(19) United States
(12) Patent Application Publication
(10) Pub. No.: US 2018/0369939 A1
(43) Pub. Date: Dec. 27, 2018

(54) CUT-OFF SAW

(71) Applicant: MILWAUKEE ELECTRIC TOOL CORPORATION, Brookfield, WI (US)

(72) Inventors: Jacob N. Zimmerman, Pewaukee, WI (US); Andrew R. Wyler, Pewaukee, WI (US); Gabriel M. Vara, Sharon, WI (US)

(21) Appl. No.: 16/018,219

(22) Filed: Jun. 26, 2018

Related U.S. Application Data
(60) Provisional application No. 62/524,770, filed on Jun. 26, 2017.

(51) Int. Cl. B23D 47/12; B23D 45/16; B23D 47/02; B23D 61/02

(52) U.S. Cl. CPC B23D 47/12; B23D 61/02; B23D 47/02; B23D 45/16

(57) ABSTRACT

A power tool includes a housing and a support arm extending from the housing and defining a longitudinal axis. The support arm includes a first arm portion coupled to the housing and a second arm portion coupled to the first arm portion. The power tool further includes a drive pulley coupled to the first arm portion. The drive pulley defines a first axis. A driven pulley is coupled to the second arm portion and defines a second axis spaced from the first axis. A synchronous belt connects the drive pulley and the driven pulley. The second arm portion is movable relative to the first arm portion between a first configuration and a second configuration offset 180 degrees from the first configuration about the longitudinal axis. A distance between the first axis and the second axis is substantially the same in both the first configuration and the second configuration.

### CROSS-REFERENCE TO RELATED APPLICATIONS

This application claims priority to co-pending U.S. Provisional Patent Application No. 62/524,770, filed on Jun. 26, 2017, the entire content of which is incorporated herein by reference.

### BACKGROUND OF THE INVENTION

The present disclosure relates to cut-off saws, and more particularly to battery powered cut-off saws.

### SUMMARY OF THE INVENTION

In one aspect, a power tool includes a housing and a support arm extending from the housing and defining a longitudinal axis. The support arm includes a first arm portion coupled to the housing and a second arm portion coupled to the first arm portion. The power tool further includes a drive pulley coupled to the first arm portion. The drive pulley defines a first axis. A driven pulley is coupled to the second arm portion and defines a second axis spaced from the first axis. The power tool also includes a synchronous belt connecting the drive pulley and the driven pulley. The second arm portion is movable relative to the first arm portion between a first configuration and a second configuration offset 180 degrees from the first configuration about the longitudinal axis. A distance between the first axis and the second axis is substantially the same in both the first configuration and the second configuration.

In another aspect, a power tool includes a housing, a motor supported within the housing, the motor having an output shaft operable at maximum speed greater than 10,000 revolutions per minute, and a battery configured to power the motor, the battery having an output voltage greater than 40 volts. A support arm extends from the housing and defines a longitudinal axis. The support arm includes a first arm portion coupled to the housing and a second arm portion coupled to the first arm portion. A drive pulley is coupled to the output shaft, which is rotatably coupled to the first arm portion. The drive pulley defines a first axis. A driven pulley is coupled to the second arm portion and defines a second axis spaced from the first axis. The power tool also includes a synchronous belt connecting the drive pulley and the driven pulley, and a cutting wheel coupled to the driven pulley, the cutting wheel having a diameter greater than 9 inches. The second arm portion is movable relative to the first arm portion between a first configuration and a second configuration offset 180 degrees from the first configuration about the longitudinal axis, thereby relocating the cutting wheel to another side of the support arm. A distance between the first axis and the second axis is substantially the same in both the first configuration and the second configuration.

In another aspect, a power tool includes a housing having an upper portion and a lower portion, a motor supported within the lower portion, a battery configured to provide power to the motor, and a battery receptacle disposed on the upper portion of the housing, the battery being removably coupled to the receptacle. The battery receptacle includes a guide rail defining an insertion and removal axis of the battery, a recessed portion adjacent the guide rail, the recessed portion having a drainage surface forming an acute included angle with the insertion and removal axis, and a drainage hole located proximate an end of the drainage surface. The drainage surface is configured to direct fluid that infiltrates an interface between the battery and the battery receptacle toward the drainage hole. The power tool further includes a support arm extending from the housing and defining a longitudinal axis, the support arm including a first arm portion coupled to the housing and a second arm portion coupled to the first arm portion. A drive pulley is coupled to the first arm portion and defines first axis. A driven pulley is coupled to the second arm portion and defines a second axis spaced from the first axis. The power tool also includes a synchronous belt connecting the drive pulley and the driven pulley. The second arm portion is movable relative to the first arm portion between a first configuration and a second configuration offset 180 degrees from the first configuration about the longitudinal axis, and a distance between the first axis and the second axis is substantially the same in both the first configuration and the second configuration.

In another aspect, a power tool includes a housing having an upper portion and a lower portion, a motor supported within the lower portion, a battery configured to provide power to the motor, a battery receptacle disposed on the upper portion of the housing. The battery is removably coupled to the receptacle. The battery receptacle includes a guide rail defining an insertion and removal axis of the battery and a recessed portion adjacent the guide rail. The recessed portion has a drainage surface forming an acute included angle with the insertion and removal axis. The battery receptacle also includes a drainage hole located proximate an end of the drainage surface. The drainage surface is configured to direct fluid that infiltrates an interface between the battery and the battery receptacle toward the drainage hole.

In another aspect, a cut-off saw includes a housing, a motor supported within the housing, the motor having an output shaft operable at maximum speed greater than 10,000 revolutions per minute, and a battery configured to power the motor. The battery has an output voltage greater than 40 volts. The cut-off saw also includes a drive pulley coupled to the output shaft, a driven pulley connected to the drive pulley by a synchronous belt, and a cutting wheel coupled to the driven pulley. The cutting wheel has a diameter greater than 9 inches.

Other aspects of the disclosure will become apparent by consideration of the detailed description and accompanying drawings.

### BRIEF DESCRIPTION OF THE DRAWINGS

FIG. 1 is a perspective view of a cut-off saw according to an embodiment of the disclosure.

FIG. 2 is a cross-sectional view of the saw of FIG. 1, taken along line 2-2 in FIG. 1.

FIG. 3 is a perspective view of the saw of FIG. 1, illustrating a drive train of the saw.

FIG. 4 is a perspective view illustrating a battery receptacle of the saw of FIG. 1.

FIG. 5 is a cross-sectional view taken along line 5-5 in FIG. 4.

FIG. 6A is a perspective view illustrating a drainage surface of the battery receptacle of FIG. 4.

FIG. 6B is a cross-sectional view illustrating a water drainage path.

FIG. 7 is a cross-sectional view taken along line 7-7 in FIG. 1.

FIG. 8 is a cross-sectional view taken along line 8-8 in FIG. 1.

FIG. 9 is an exploded view of a support arm of the saw of FIG. 1.

FIG. 10 is a perspective view of the support arm of FIG. 9 in a first configuration.

FIG. 11 is a perspective view of the support arm of FIG. 9 in a second configuration.

FIG. 12 is a perspective view of a portion of the saw of FIG. 1 with the support arm in the first configuration.

FIG. 13 is a perspective view of a portion of the saw of FIG. 1 with the support arm in the second configuration.

FIG. 14 is another perspective view of the portion of the saw of FIG. 13.

FIG. 15 is an exploded view of a portion of the saw of FIG. 1.

Before any embodiments of the disclosure are explained in detail, it is to be understood that the disclosure is not limited in its application to the details of construction and the arrangement of components set forth in the following description or illustrated in the accompanying drawings. The disclosure is capable of supporting other embodiments and of being practiced or of being carried out in various ways.

### DETAILED DESCRIPTION

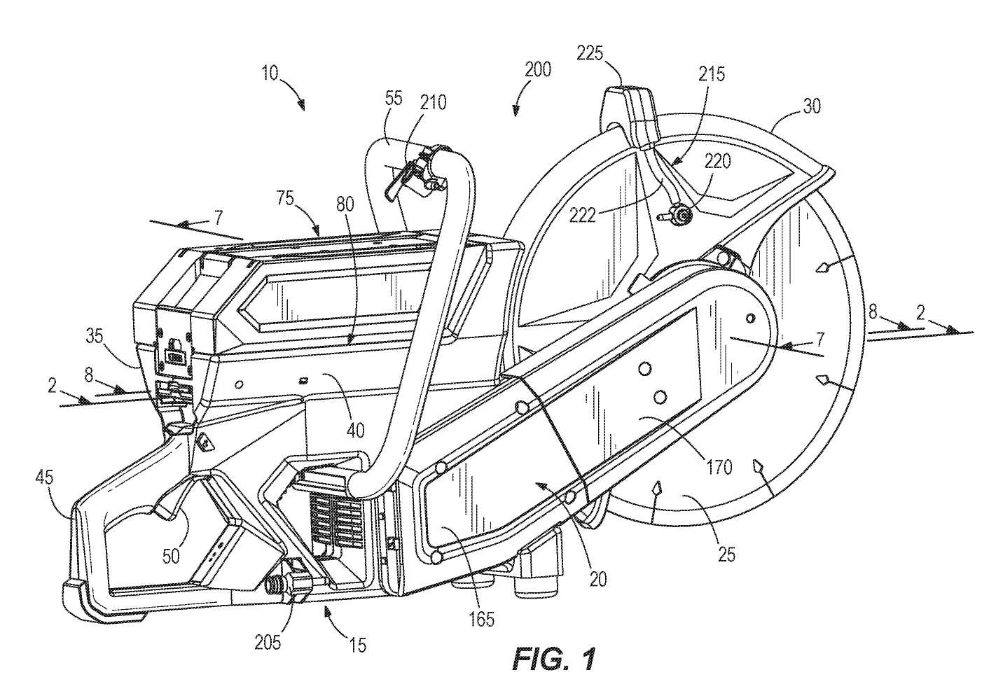

FIG. 1 illustrates a handheld power tool 10, which is a cut-off saw in the illustrated embodiment. The saw 10 includes a housing 15, a support arm 20 coupled to and extending from the housing 15, a cutting wheel 25 carried by the support arm 20, and a guard 30 covering a portion of the circumference of the cutting wheel 25. The cutting wheel 25 can be a blade, an abrasive disk, or any other rotatable element capable of removing material from a workpiece. In the illustrated embodiment, the cutting wheel 25 has a diameter greater than 9 inches and is preferably 14 inches in diameter. In other embodiments, the cutting wheel 25 can be between about 10 inches and about 16 inches in diameter.

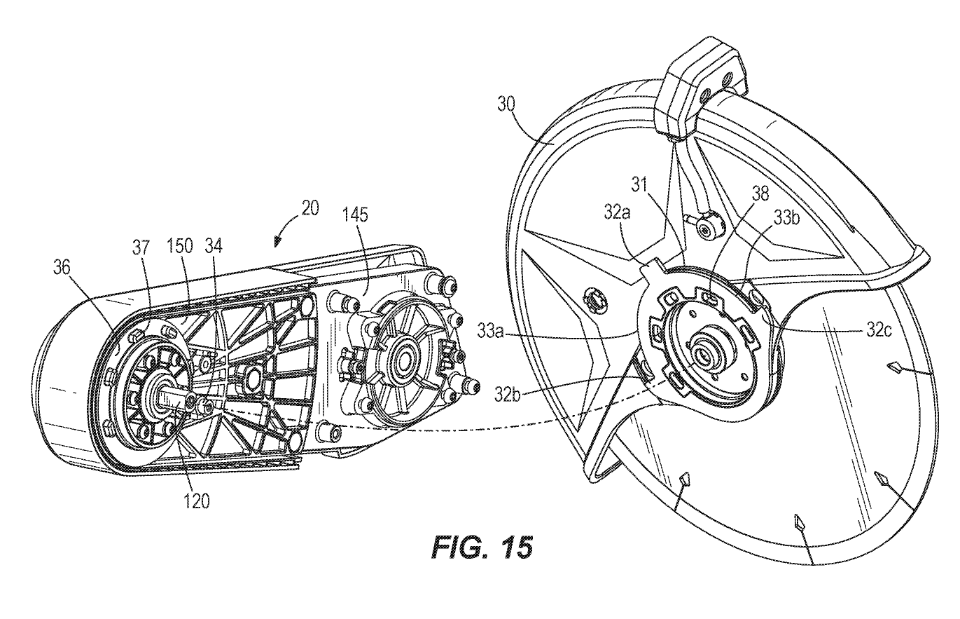

With reference to FIG. 15, the guard 30 is rotatably coupled to the support arm 20 to provide a variety of operating positions that expose different circumferential portions of the cutting wheel 25. This advantageously allows the saw 10 to be used in a variety of cutting positions. In the illustrated embodiment, a stop member 31 is coupled for co-rotation with the guard 30 and includes first, second, and third projections 32a, 32b, 32c that extend in a radially outward direction. A first travel region 33a is defined between the first and second projections 32a, 32b, and a second travel region 33b is defined between the first and third projections 32a, 32c. In the illustrated embodiment, a post 34 (which may be, for example, the head of a cap screw) projects from the support arm 20 into one of the travel regions 33a, 33b, depending on an installation position of the guard 30.

With continued reference to FIG. 15, the post 34 is engageable with the projections 32a, 32b to limit movement of the guard 30 to first and second rotational positions that define the ends of the first travel region 33a. Alternatively, the post 34 is engageable with the projections 32a, 32c to limit movement of the guard 30 to third and fourth rotational positions that define the ends of the second travel region 33b. In some embodiments, a user may remove and reposition the guard 30 to align the post 34 with either the first travel region 33a or the second travel region 33b, to permit movement of the guard 30 between the first and second rotational positions or the third and fourth rotational positions, respectively. In the illustrated embodiment, an elastomeric gasket 36 is disposed between the guard 30 and the support arm 20. The gasket 36 includes axially protruding portions 37 that are received in corresponding recesses 38 in the guard 30 such that the gasket 36 is coupled for co-rotation with the guard 30. The gasket provides a frictional engagement between the guard 30 and the support arm 20 to inhibit inadvertent rotation of the guard 30.

Referring again to FIG. 1, the illustrated housing 15 is a clamshell housing having left and right cooperating halves 35, 40. A first or rear handle 45 extends from a rear portion of the housing 15 in a direction generally opposite the support arm 20. A trigger 50 for operating the saw 10 is located on the rear handle 45. In the illustrated embodiment, the saw 10 also includes a second or forward handle 55 that wraps around an upper portion of the housing 15. The forward handle 55 and the rear handle 45 provide grip areas to facilitate two-handed operation of the saw 10.

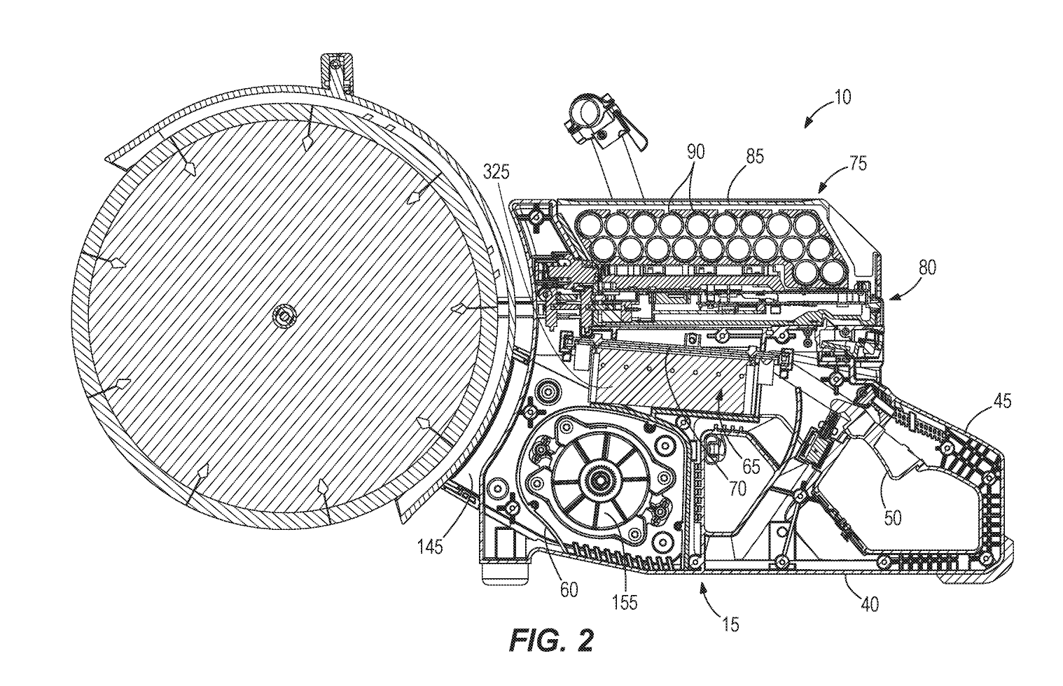

Referring to FIG. 2, the saw 10 further includes a motor housing 60 formed within the housing 15 at a front, lower portion of the housing 15. An electric motor (not shown) is mounted in the motor housing 60. The motor is preferably a brushless direct-current (“BLDC”) motor. Operation of the motor is governed by a motor control system 65 including a printed circuit board (“PCB”) 70.

With reference to FIGS. 1 and 2, the illustrated saw 10 is a cordless electric saw and includes a battery 75 that provides power to the motor. The battery 75 is removably coupled to a battery receptacle 80, which is located on the upper portion of the housing 15 in the illustrated embodiment (FIG. 1). As such, the forward handle 55 at least partially surrounds the battery receptacle 80 and the battery 75, when the battery 75 is coupled to the receptacle 80. In other embodiments, the saw 10 may be a corded electric saw configured to receive power from a wall outlet or other remote power source. The illustrated battery 75 is a power tool battery pack and includes a battery housing 85 and a plurality of rechargeable battery cells 90 (FIG. 2) disposed within the housing 85. The battery cells 90 are lithium-based battery cells but can alternatively have any other suitable chemistry. In the illustrated embodiment, the battery 75 has a nominal output voltage of about 80V. In other embodiments, the battery 75 can have a different nominal voltage, such as, for example, 36V, 40V, 72V, between 36V and about 80V, or greater than 40V.

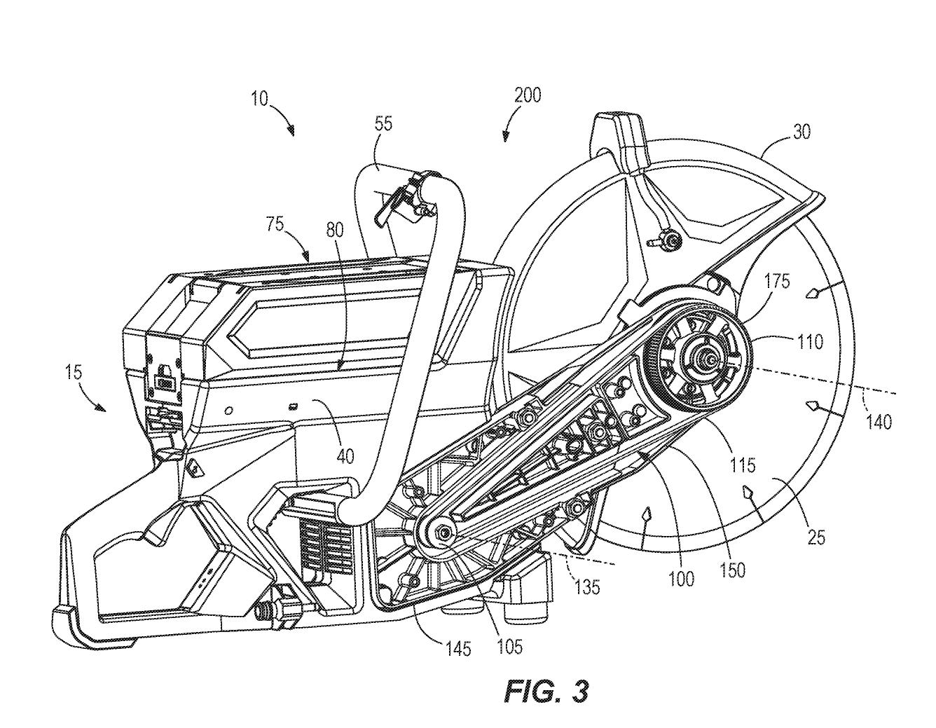

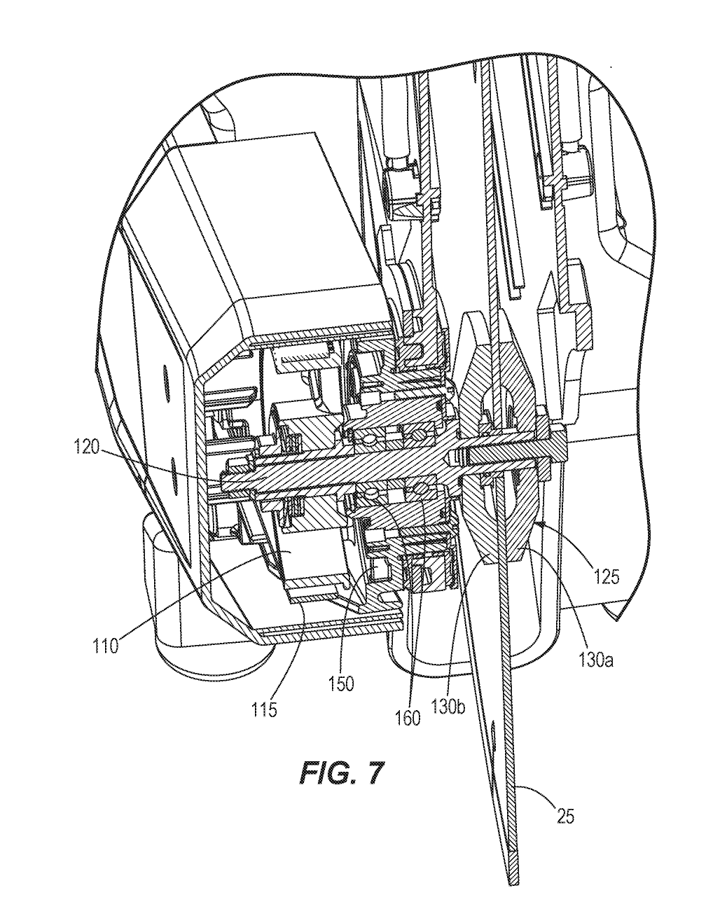

The saw 10 includes a drive assembly 100 for transmitting torque from the motor to the cutting wheel 25 (FIG. 3). The drive assembly 100 includes a drive pulley 105 fixed to an output shaft (not shown) of the motor, a driven pulley 110 connected to the drive pulley 105 by a belt 115, a spindle 120 fixed to the driven pulley 110 (FIG. 7), and a clamp assembly 125 coupled to the spindle 120. In some embodiments, a clutch mechanism may be provided between the output shaft and the drive pulley 105 to selectively interrupt torque transfer between the output shaft and the drive pulley 105. The clamp assembly 125 includes clamping disks 130a, 130b that hold the cutting wheel 25.

With reference to FIGS. 1-3, the drive pulley 105 defines a first rotational axis 135, and the driven pulley 110 defines a second rotational axis 140 spaced from the first rotational axis (FIG. 3). The support arm 20 includes a first arm portion 145 coupled to the housing 15 and a second arm portion 150 coupled to the first arm portion 145. In the illustrated embodiment, the first arm portion 145 includes a mount 155 to which the motor is directly fastened (FIG. 2). The output shaft of the motor extends through the first arm portion 145 to the drive pulley 105 (FIG. 3). The spindle 120 extends through the second arm portion 150 and is supported by two bearings 160. The driven pulley 110 and the clamp assembly 125 are located on opposite sides of the second arm portion 150. In the illustrated embodiment, first and second covers 165, 170 (FIG. 1) are secured to the first and second arm portions 145, 150 to enclose the drive assembly 100 during ordinary operation. The covers 165, 170 are coupled to the respective arm portions 145, 150 by screws, but can be attached via a snap fit or any other suitable manner in other embodiments.

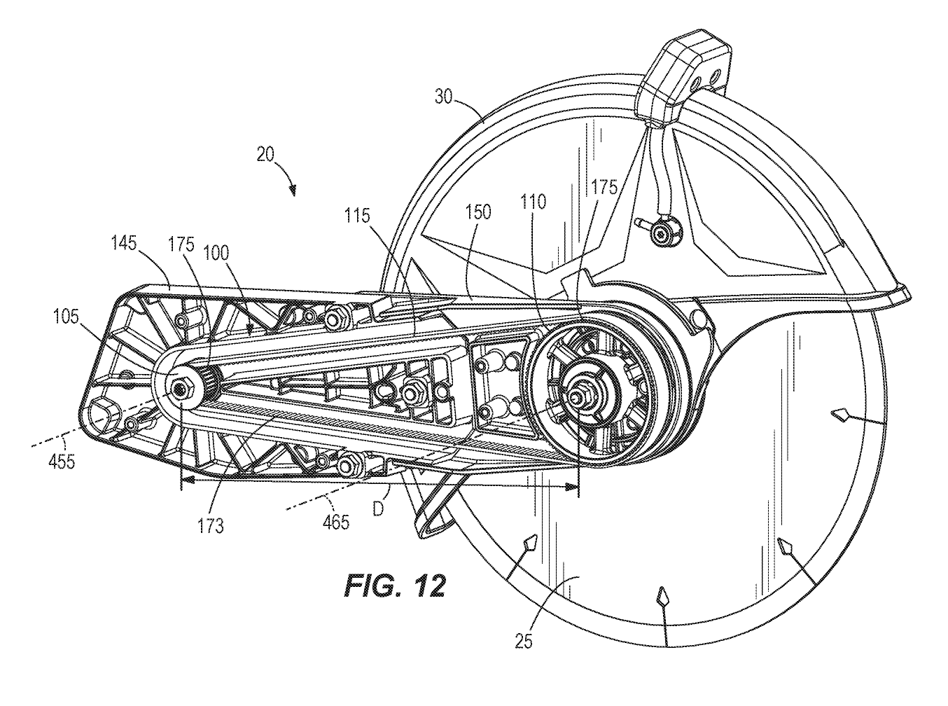

With reference to FIG. 12, the illustrated belt 115 is a synchronous belt having a plurality of teeth 173 extending laterally across a width of the belt 115. The teeth 173 are engageable with corresponding teeth 175 on the driven pulley 110 and the drive pulley 105. The toothed engagement between the synchronous belt 115 and the pulleys 105, 110 prevents the belt 115 from slipping under high loads as may occur with a v-belt. In addition, the relatively flat profile of the synchronous belt 115 allows the drive pulley 105 to be smaller in diameter when compared with a v-belt configuration. As such, a higher reduction can be achieved between the drive pulley 105 and the driven pulley 110. For example, in some embodiments, the drive pulley 105 and the driven pulley 110 may be sized to provide a 4:1 reduction from the motor output shaft to the spindle 120. In other embodiments, the drive pulley 105 and the driven pulley 110 may be sized to provide between a 3:1 and a 5:1 reduction from the motor output shaft to the spindle 120.

This relatively high reduction ratio advantageously eliminates the need for a separate gearbox or gear reduction stage between the motor output shaft and the drive pulley 105, thereby improving mechanical efficiency and reducing the size, cost, and weight of the drive assembly 100. In the illustrated embodiment, the drive assembly 100 has a mechanical efficiency (i.e. a ratio of power at the spindle 120 to power at the output shaft of the motor) between about 95 percent and about 98 percent. In contrast, a drive assembly requiring a gearbox may have a mechanical efficiency of only about 92 percent or less. The relatively high reduction ratio also can allow the motor to spin at a higher rate compared to v-belt and direct drive configurations, which can improve cooling and performance. In some embodiments, the motor has a maximum output speed greater than 10,000 RPM. In other embodiments, the motor has a maximum output speed between about 10,000 RPM and about 30,000 RPM. In the illustrated embodiment, the motor has a maximum output speed of about 20,000 RPM. Finally, the synchronous belt 115 advantageously does not require tensioning. Accordingly, the saw 10 need not include means for adjusting the tension of the belt 115, which reduces the weight, complexity, and cost of the drive assembly 100. In addition, the saw's performance will stay relatively consistent over the lifetime of the belt 115. In contrast, v-belts typically stretch after a period of ordinary operation and must be manually or automatically tensioned from time to time to prevent slippage.

The drive assembly 100 of the saw 10 advantageously provides for quieter operation than typical cut-off saws. Table 1 lists sound pressure levels in decibels (dBa) measured during operation of the saw 10. The sound pressure levels were measured when operating the saw 10 with a diamond cutting wheel 25, a composite cutting wheel 25, and with no cutting wheel 25 attached. The sound pressure levels were measured in two locations: at the front of the saw 10, and at a typical operator position (i.e. above and behind the rear handle 45).

TABLE 1
SOUND PRESSURE LEVEL TESTS

| Cutting | Measurement Location | |
|---|---|---|
| Wheel Material | Front of Tool | Operator Position |
| Diamond | 88.2 dBa | 86.3 dBa |
| Composite | 75.9 dBa | 79.3 dBa |
| No Cutting Wheel | 75.3 dBa | 77.9 dBa |

As evident from the data in Table 1, the saw 10 produces less than 90 dBa during operation. In some embodiments, the saw 10 produces less than 85 dBa during operation. In some embodiments, the saw 10 produces less than 80 dBa during operation. In contrast, it has been found that other cut-off saws on the market produce more than 95 dBa during operation. Human perception of sound pressure is such that an increase of 10 dBa sounds approximately twice as loud. Accordingly, it is evident that the saw 10 would be perceived by an operator as significantly quieter than other cut-off saws.

The saw 10 also advantageously produces less vibration than typical cut-off saws. Table 2 lists hand-arm vibration (HAV) values for the saw 10. Accelerometers were positioned on the rear handle 45 (Location #1) and on the forward handle 55 (Location #2). The HAV values were determined during a wet plunge cutting operation and during no-load operation using an HVM100 Human Vibration Meter produced by LARSON DAVIS. The accelerometers measured acceleration along all three axes, and the HVM100 calculated the HAV values based on vector sums of the measured accelerations.

TABLE 2
VIBRATION TESTS

| | Plunge Wet Cut, | Plunge Wet Cut, | No Load, | No Load, |
|---|---|---|---|---|
| | Location #1 | Location #2 | Location #1 | Location #2 |
| | (m/s²) | (m/s²) | (m/s²) | (m/s²) |
| Trial 1 | 6.18 | 6.30 | 2.83 | 3.25 |
| Trial 2 | 6.00 | 6.06 | 2.76 | 2.65 |
| Trial 3 | 5.69 | 6.06 | 2.85 | 2.73 |
| Trial 4 | 5.80 | 5.41 | 2.84 | 2.74 |
| Trial 5 | 4.99 | 7.01 | 2.85 | 2.79 |
| Average | 5.73 | 6.17 | 2.83 | 2.83 |

As evident from the data in Table 2, the saw 10 may produce an average no-load HAV between about 2.7 m/s² and about 3.0 m/s² at either or both the front handle 55 and the rear handle 45. For example, the illustrated saw 10 produces an average no-load HAV of 2.83 m/s² at both the front handle 55 and the rear handle 45. In other embodiments, the average no-load HAV at the front handle 55 or the rear handle 45 may differ. In some embodiments, the saw 10 may produce an average plunge cut HAV between about 5 m/s² and about 7 m/s², or between about 5 m/s² and about 6.2 m/s² in other embodiments, at either or both the front handle 55 and the rear handle 45. For example, the illustrated saw 10 produces an average plunge cut HAV less than about 6.2 m/s² at the front handle 55 and less than about 5.8 m/s² at the rear handle 45.

With reference to FIG. 1, the illustrated saw 10 further includes a fluid distribution system 200. The fluid distribution system 200 includes a connector 205 coupled to the lower portion of the housing 15, a control valve 210 coupled to the forward handle 55, and a distributor 215 coupled to the guard 30. A supply line (not shown) can be attached to the connector 205 to provide fluid such as water to the fluid distribution system 200 from an external source (not shown). A first line (not shown) extends from the connector 205 to the control valve 210, and a second line (not shown) extends from the control valve 210 to the distributor 215. In the illustrated embodiment, the distributor 215 includes a pair of spray nozzles 220 disposed on opposite sides of the guard 30 connected by a supply line 222. The spray nozzles 220 are operable to discharge fluid onto each side of the cutting wheel 25 for cooling, lubrication, and dust abatement. In the illustrated embodiment, an auxiliary handle 225 is attached to the guard 30 through which a portion of the supply line 222 extends that can be grasped by a user to facilitate adjusting an angular position of the guard 30. However, the handle 225 may alternatively be located elsewhere on the guard 30 remote from the supply line 222.

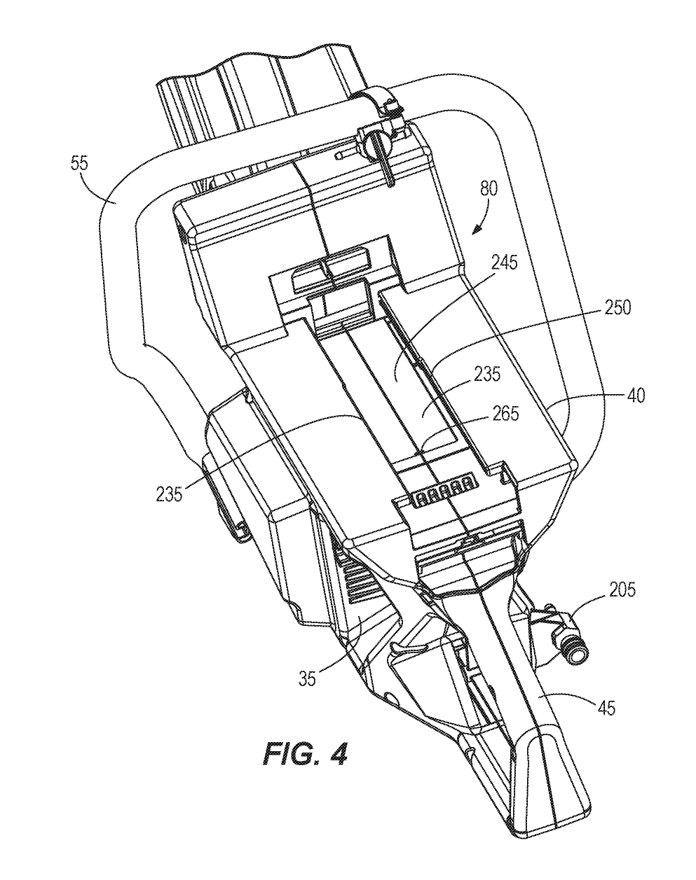

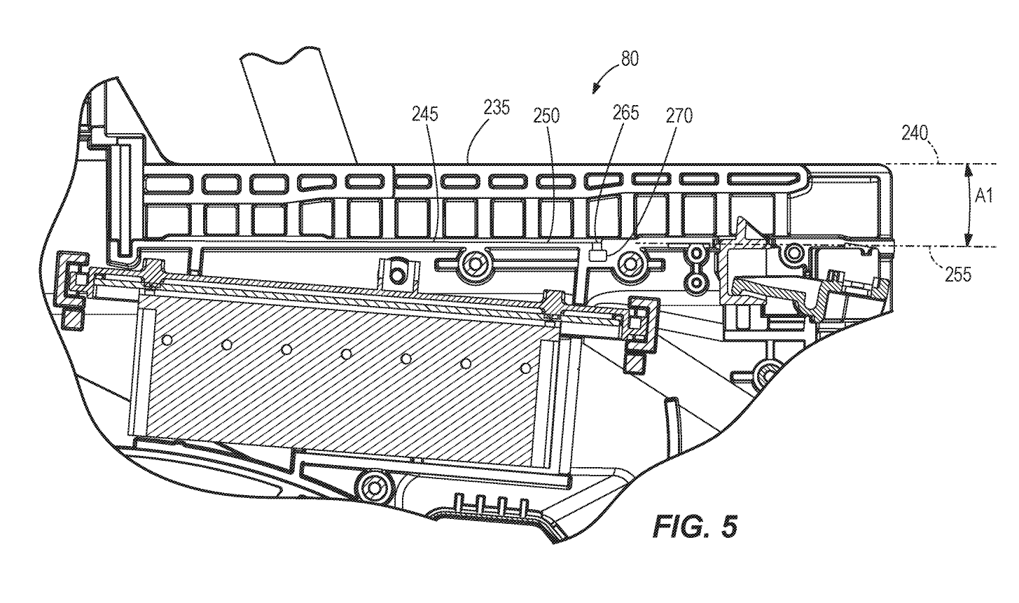

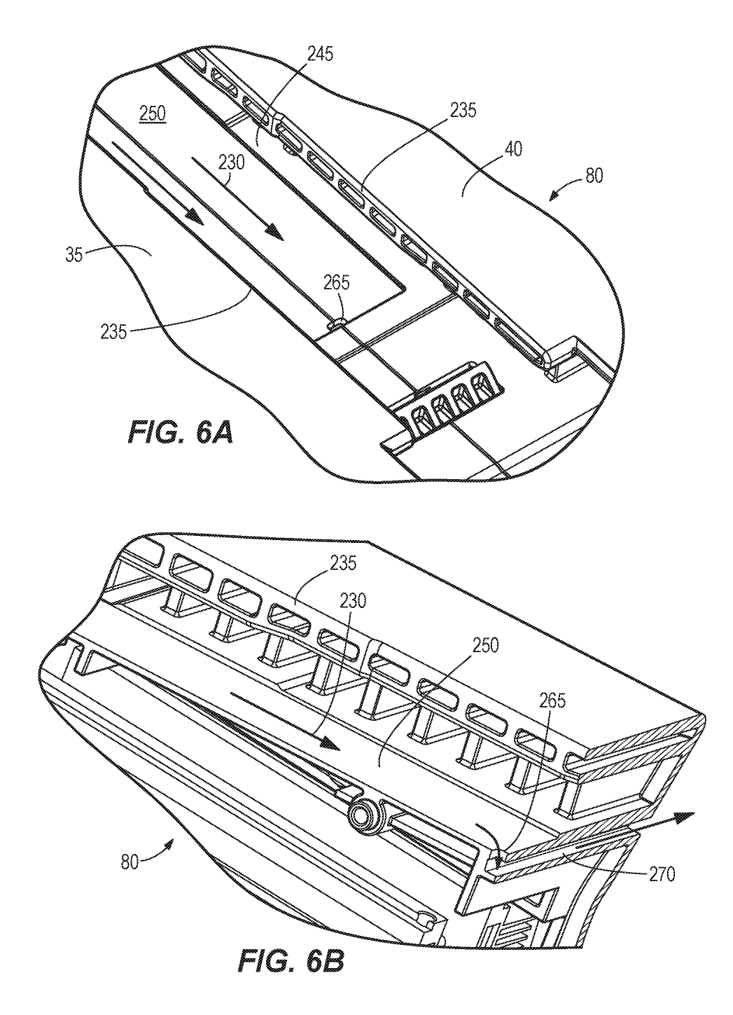

Referring to FIGS. 4-6B, the battery receptacle 80 includes a drainage path 230 (FIGS. 6A and 6B) to direct fluid (e.g., from the fluid distribution system 200) from the interface between the battery housing 85 and the battery receptacle 80. The illustrated battery receptacle 80 includes a pair of guide rails 235 that define an insertion and removal axis 240 of the battery 75 (FIG. 5). The battery receptacle 80 further includes a recessed portion 245 between the guide rails 235. When the battery 75 is positioned in the battery receptacle 80, a lower-most surface of the battery 75 is positioned adjacent the recessed portion 245 of the receptacle 80. The recessed portion 245 of the receptacle 80 has an angled drainage surface 250 that defines an axis 255, which forms an acute included angle A1 with the insertion and removal axis 240. In some embodiments, the angle A1 is between about 0.5 degrees and about 5 degrees. The drainage surface 250 leads to a drainage hole 265 located at an intersection between the left and right housing halves 35, 40 (FIGS. 4 and 6A). The drainage hole 265 communicates with a closed passage 270 that extends laterally through the housing 15, to the exterior of the housing 15.

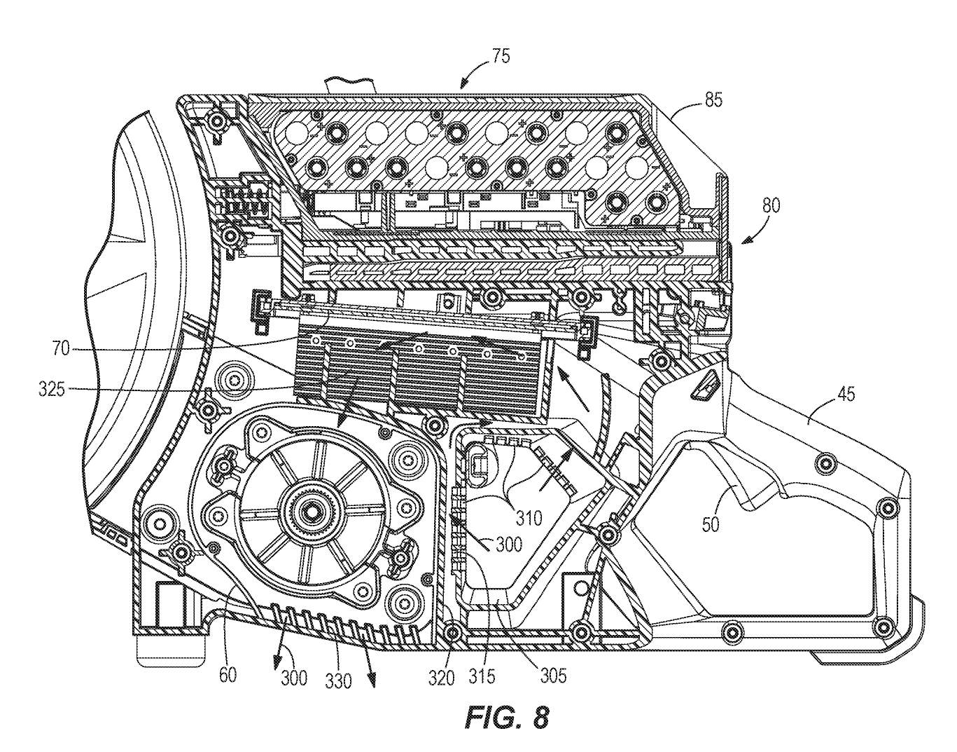

With reference to FIG. 8, the saw 10 further includes a closed cooling path 300 that extends through the housing 15. The illustrated housing 15 includes an aperture 305 that extends laterally through the housing 15, at a position between the rear handle 45 and the motor housing 60. Slotted air intake openings 310 line the aperture 305 and communicate with the interior of the housing 15. In the illustrated embodiment, the aperture 305 has a generally pentagonal or five-sided cross-section, and the air intake openings 310 are positioned on three of the five sides of the aperture 305. The position of the air intake openings 310 in the aperture 305 helps to shield the openings 310 from fluid, dust, and debris present during operation of the saw 10. In other embodiments, the air intake openings 310 may be arranged and positioned differently. Additionally, the saw 10 may not include the aperture 305, and may draw intake air from other locations, such as from proximate the rear handle 45.

With continued reference to FIG. 8, the air intake openings 310 communicate with an air space 315 that is separated from the interior of the motor housing 60 by a wall 320. Air drawn through the air intake openings 310 is routed along the cooling path 300 by the wall 320 and various other walls and baffles, which direct the air past a finned heat sink 325 to cool the PCB 70. After passing over the heat sink 325, the air can enter the motor housing 60, cooling the motor before being discharged through slotted exhaust openings 330 located on the bottom portion of the housing 15. A fan (not shown) is provided with the motor to induce the airflow along the cooling path 300 during operation of the saw 10.

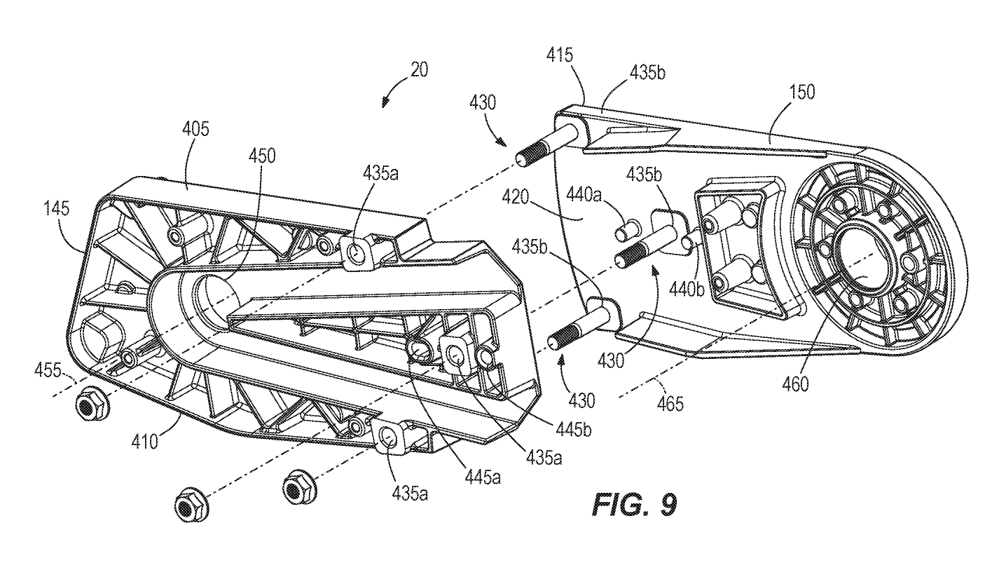

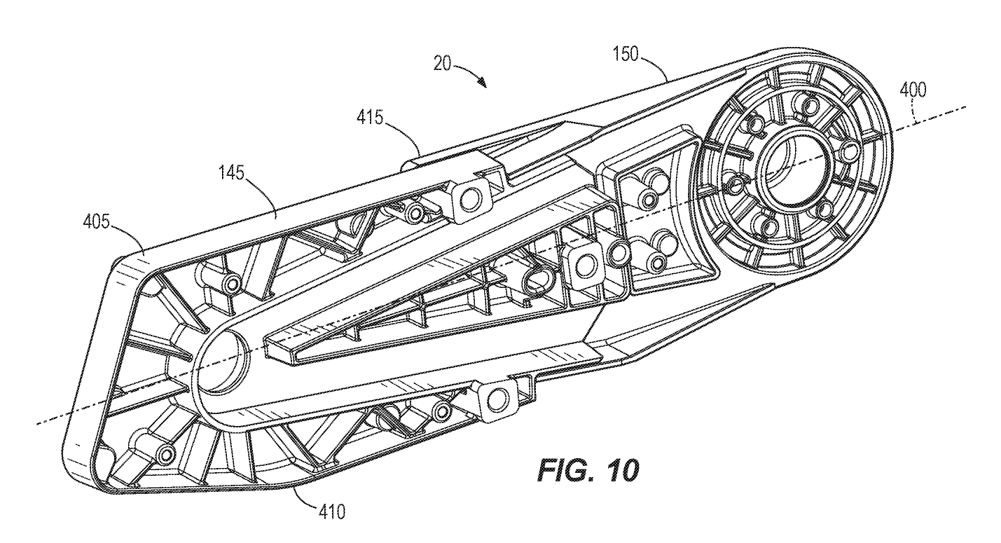

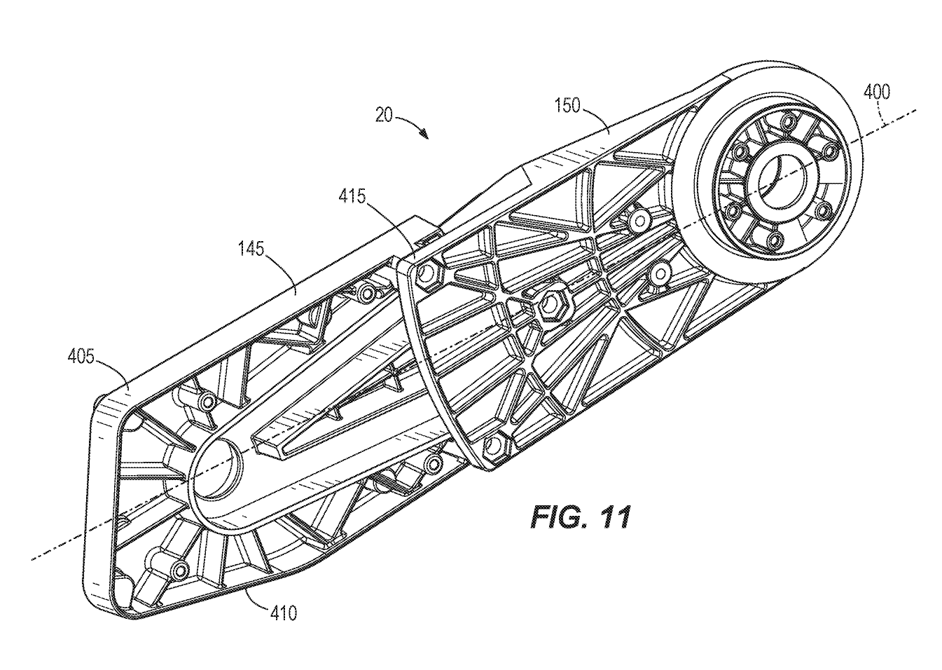

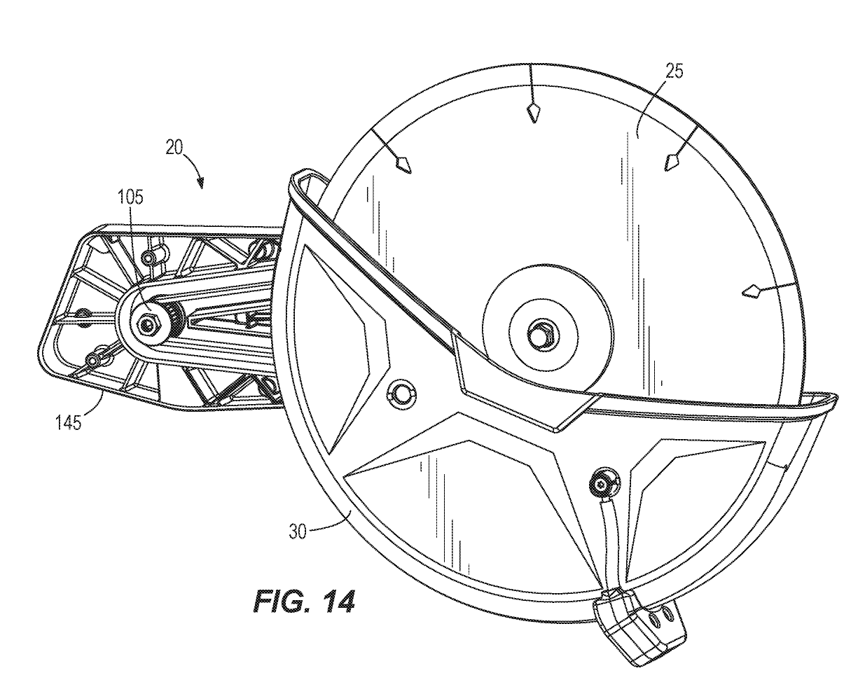

Referring to FIGS. 3 and 9-14, the support arm 20 of the saw 10 is adjustable between a first or inboard configuration (FIGS. 3, 10, and 12) in which the cutting wheel 25 is generally aligned with a longitudinal mid-plane of the saw 10 and a second or outboard configuration (FIGS. 11, 13, and 14) in which the cutting wheel 25 is offset from the longitudinal mid-plane of the saw 10. In the illustrated embodiment, the support arm 20 is adjustable between the first and second configurations by rotating the second arm portion 150 by 180 degrees about a longitudinal axis 400 of the support arm 20 (FIGS. 10 and 11). The first arm portion 145 includes first and second opposite, lateral sides 405, 410. The second arm portion includes a flange 415 having an inner side 420 (FIG. 9). In the first configuration, the inner side 420 of the flange abuts the first lateral side 405 of the first arm portion 145 (FIG. 10), and in the second configuration, the inner side 420 of the flange 415 abuts the second lateral side 410 of the first arm portion 145 (FIG. 11). In the illustrated embodiment, the second arm portion 150 is removably secured to the first arm portion 145 by three fastener assemblies 430 (i.e. nut and bolt assemblies) that extend through corresponding bores 435a, 435b in the first and second arm portions 145, 150 (FIG. 9). To facilitate proper alignment of the second arm portion 150 relative to the first arm portion 145, the second arm portion 150 includes first and second locator pins 440a, 440b that are received within corresponding first and second locator openings 445a, 445b in the first arm portion 145. In the illustrated embodiment, the first locator opening 445a is oval shaped and elongated along the longitudinal axis 400 to allow for tolerance variations.

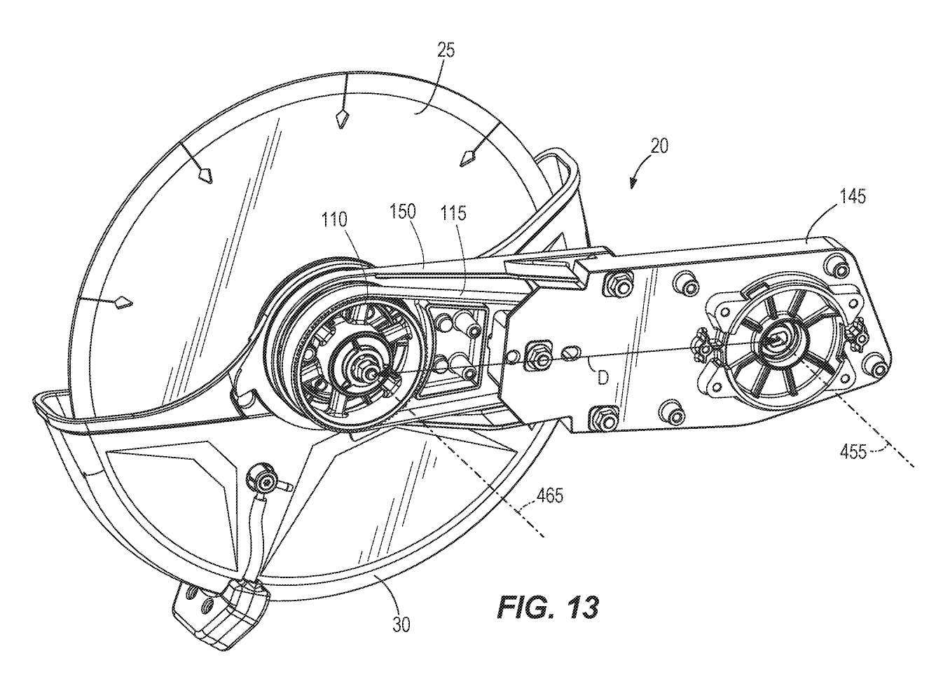

The first arm portion 145 includes a drive opening 450 that defines a first axis 455 coaxial with the rotational axis 135 of the drive pulley 105, and the second arm portion 150 includes a spindle opening 460 that defines a second axis 465 coaxial with the rotational axis 140 of the driven pulley 110 (FIG. 9). A distance D between the first and second axes 455, 465 is substantially the same, regardless of whether the support arm 20 is in the first configuration (FIG. 12) or the second configuration (FIG. 13). Thus, the belt 115 extends the same span and a user need not adjust the tension of the belt 115 when changing the support arm 20 between the first and second configurations.

Various features of the invention are set forth in the following claims.

1. A power tool comprising:
a housing;
a support arm extending from the housing and defining a longitudinal axis, the support arm including a first arm portion coupled to the housing and a second arm portion coupled to the first arm portion;
a drive pulley coupled to the first arm portion, the drive pulley defining a first axis;
a driven pulley coupled to the second arm portion, the driven pulley defining a second axis spaced from the first axis; and
a synchronous belt connecting the drive pulley and the driven pulley,
wherein the second arm portion is movable relative to the first arm portion between a first configuration and a second configuration offset 180 degrees from the first configuration about the longitudinal axis, and
wherein a distance between the first axis and the second axis is substantially the same in both the first configuration and the second configuration.

2. The power tool of claim 1, further comprising a spindle fixed to the driven pulley; and a cutting wheel coupled to the spindle.

3. The power tool of claim 2, wherein the cutting wheel has a diameter of at least nine inches.

4. The power tool of claim 2, wherein the first configuration defines an inboard configuration in which the cutting wheel is generally aligned with a longitudinal mid-plane of the power tool, and wherein the second configuration defines an outboard configuration in which the cutting wheel is offset from the longitudinal mid-plane.

5. The power tool of claim 1, wherein the first arm portion includes a first side and a second side opposite the first side, wherein the second arm portion includes a flange having an inner side, wherein the inner side abuts the first side of the first arm portion in the first configuration, and wherein the inner side abuts the second side of the first arm portion in the second configuration.

6. The power tool of claim 1, wherein the first arm portion includes a plurality of locator pins receivable within a corresponding plurality of locator openings in the second arm portion.

7. The power tool of claim 6, wherein the plurality of locator openings include a first locator opening that is elongated in a direction parallel to the longitudinal axis.

8. The power tool of claim 1, further comprising an electric motor configured to directly drive the drive pulley, wherein the drive pulley and the driven pulley are configured to provide a speed reduction ratio from the drive pulley to the driven pulley between 3:1 and 5:1.

9. The power tool of claim 1, further comprising:
a motor supported within the housing; and
a battery configured to power the motor.

10. The power tool of claim 11, wherein the battery has an output voltage greater than 40 volts.

11. The power tool of claim 9, further comprising:
a spindle fixed to the driven pulley; and
a cutting wheel coupled to the spindle,
wherein the cutting wheel has a diameter greater than 9 inches.

12. The power tool of claim 9, wherein the motor includes an output shaft operable at a maximum speed greater than 10,000 revolutions per minute.

13. The power tool of claim 9, wherein operation of the power tool produces a sound pressure less than 85 decibels.

14. The power tool of claim 9, further comprising:
a spindle fixed to the driven pulley; and
a cutting wheel coupled to the spindle,
wherein the cutting wheel has a diameter greater than 9 inches, wherein the battery has an output voltage greater than 40 volts, wherein the motor includes an output shaft operable at a maximum speed greater than 10,000 revolutions per minute, and wherein operation of the power tool produces a sound pressure less than 90 decibels.

15. The power tool of claim 1, further comprising a handle configured to be grasped by an operator during operation of the power tool, wherein the power tool is configured to produce a hand-arm vibration at the handle less than 3.0 m/s² during no-load operation.

16. A power tool comprising:
a housing;
a motor supported within the housing, the motor having an output shaft operable at maximum speed greater than 10,000 revolutions per minute;
a battery configured to power the motor, the battery having an output voltage greater than 40 volts;
a support arm extending from the housing and defining a longitudinal axis, the support arm including a first arm portion coupled to the housing and a second arm portion coupled to the first arm portion;
a drive pulley coupled to the output shaft, which is rotatably coupled to the first arm portion, the drive pulley defining a first axis;
a driven pulley coupled to the second arm portion, the driven pulley defining a second axis spaced from the first axis;
a synchronous belt connecting the drive pulley and the driven pulley; and
a cutting wheel coupled to the driven pulley, the cutting wheel having a diameter greater than 9 inches,
wherein the second arm portion is movable relative to the first arm portion between a first configuration and a second configuration offset 180 degrees from the first configuration about the longitudinal axis, thereby relocating the cutting wheel to another side of the support arm, and
wherein a distance between the first axis and the second axis is substantially the same in both the first configuration and the second configuration.

17. The power tool of claim 16, further comprising a handle configured to be grasped by an operator during operation of the power tool, wherein the power tool is configured to produce a hand-arm vibration at the handle less than 3.0 m/s² during operation without a load on the cutting wheel.

18. The power tool of claim 17, wherein the power tool is configured to produce an average hand-arm vibration at the handle between about 5 m/s² and about 7 m/s² during a plunge-cutting operation.

19. A power tool comprising:
a housing having an upper portion and a lower portion;
a motor supported within the lower portion;
a battery configured to provide power to the motor;
a battery receptacle disposed on the upper portion of the housing, the battery being removably coupled to the receptacle, the battery receptacle including
a guide rail defining an insertion and removal axis of the battery,
a recessed portion adjacent the guide rail, the recessed portion having a drainage surface forming an acute included angle with the insertion and removal axis, and
a drainage hole located proximate an end of the drainage surface,
wherein the drainage surface is configured to direct fluid that infiltrates an interface between the battery and the battery receptacle toward the drainage hole;
a support arm extending from the housing and defining a longitudinal axis, the support arm including a first arm portion coupled to the housing and a second arm portion coupled to the first arm portion;
a drive pulley coupled to the first arm portion, the drive pulley defining a first axis;
a driven pulley coupled to the second arm portion, the driven pulley defining a second axis spaced from the first axis; and
a synchronous belt connecting the drive pulley and the driven pulley,
wherein the second arm portion is movable relative to the first arm portion between a first configuration and a second configuration offset 180 degrees from the first configuration about the longitudinal axis, and
wherein a distance between the first axis and the second axis is substantially the same in both the first configuration and the second configuration.

20. The power tool of claim 19, further comprising a handle configured to be grasped by an operator during operation of the power tool, the handle at least partially surrounding the battery receptacle, wherein the power tool is configured to produce a hand-arm vibration at the handle less than 3.0 m/s² during operation without a load on the driven pulley, and wherein the battery has an output voltage greater than 40 volts.

21-60. (canceled)
